(19) United States
(12) Patent Application Publication
(10) Pub. No.: US 2003/0174841 A1
(43) Pub. Date: Sep. 18, 2003

(54) Methods, systems, and data structures for secure data content presentation

(75) Inventors: Gabe Nault, Draper, UT (US); Lloyd Burch, Payson, UT (US)

Correspondence Address: SCHWEGMAN, LUNDBERG, WOESSNER & KLUTH, P.A., P.O. BOX 2938, MINNEAPOLIS, MN, 55402, US

(73) Assignee: Novell Inc.

(21) Appl. No.: 10/099,417

(22) Filed: Mar. 15, 2002

(51) Int. Cl. H04L 9/00

(52) U.S. Cl. 380/277

(57) ABSTRACT

Methods, systems, and data structures are provided for secure data content presentation. A client makes a request to access data content on a remote server. A key is associated with the data content. Moreover, the key and the data content are delivered to the client. In one embodiment, a proxy server generates the key and provides the data content along with the key to the client. The client validates the key prior to presenting the data content.

### FIELD OF THE INVENTION

The present invention relates to secure data content presentation, and in particular to methods, systems, and data structures used to ensure data content is not altered before being presented.

### BACKGROUND OF THE INVENTION

Providing secure data communications over the Internet is of vital importance to ensure privacy of some transactions and to ensure the integrity of data content being presented. One communication protocol used to achieve secure data communications over the Internet using a World Wide Web (WWW) browser client is a Secure Sockets Layer (SSL) communication protocol. SSL is designed to guarantee the delivery and transfer of data content in an unaltered format to a WWW browser client using an Internet connection. SSL uses a software program layer located between the Internet's Hypertext Transfer Protocol (HTTP) and Transport Control Protocol (TCP) communication layers.

Further, in recent years SSL has evolved into Transport Layer Security (TLS), which is largely based on SSL. TLS ensures privacy between software applications and users over the Internet, and prevents third party eavesdropping or tampering with any data content being transferred. TLS includes two protocols a TLS record protocol and a TLS handshake protocol. The record protocol provides connection security using encryption techniques, such as Data Encryption Standard (DES) techniques. Further, in some instances, the record protocol can be used without any encryption technique. The handshake protocol allows a client and a server to authenticate themselves to one another and to negotiate an encryption technique and cryptographic keys before any data content is transmitted between the client and the server.

Both SSL and/or TLS are integral components in most WWW browser clients and WWW servers. Correspondingly, if a web site resides on a WWW server, which supports SSL and/or TLS, then access, to specific WWW pages, can be made to require the use of SSL and/or TLS. However, SSL and TLS are not completely interoperable, since a WWW browser client cannot handle SSL communications, if only TLS is supported within the WWW browser client. Ironically, a WWW browser client, in some instances, can handle TLS delivered data content when the WWW browser client supports only SSL, even though TLS is the most recently developed protocol standard.

Yet, even SSL and TLS fail to provide for secure presentation of data content, since both SSL and TLS ensure only that the data content is securely delivered to a WWW browser client, but cannot ensure that the WWW browser client does not subsequently alter the data content before being presented within the WWW browser client. As a result, a myriad of executable instructions are often downloaded and installed within a WWW browser client that are capable of altering securely delivered data content, before the data content is presented within the WWW browser client. These executable instructions are often hidden from a user and typically are not detected by the user. Moreover, the user often downloads and installs these executable instructions when accessing seemingly innocuous WWW pages. Therefore, the user is unaware that these executable instructions are executing within the user's WWW browser client, and the user is unaware of the fact that these executable instructions are capable of dynamically altering securely delivered data content before or as the data content is presented within the user's WWW browser client.

The executable instructions are sometimes referred to as spyware or scumware and are executed within the WWW browser client when the data content is presented within the WWW browser client. Sypware or scumware can alter or add Uniform Resource Locator (URL) hypertext links in the data content, so that when a user activates an URL hypertext link, the user is unknowingly directed to a different WWW page. In most instances, marketers use spyware or scumware to force the user to view a specific WWW browser page (e.g., a WWW browser page offering a credit card). In some cases, the redirection is even more sinister, such as when a government's or an organization's WWW pages are modified within a WWW browser client to redirect a user to undesirable WWW pages (e.g., gambling, pornography, and the like).

Additionally, spyware and scumware are become increasingly popular as a technique to provide general surveillance of a user's activity on the WWW. For example, spyware or scumware can be used to alter data content such that when a user activates a hypertext link, the user is unknowingly transferred to an intermediate web site before any desired WWW page associated with the activated hypertext link is presented within the user's WWW browser client.

The intermediate web site tracks hypertext links being activated by the user and tracks information included with any sent hypertext link. This tracking is then used to market to the user unwanted products and services, and can also be used to acquire information about the user such as email addresses, phone numbers, home addresses, business addresses, employment information, income information, social security numbers, and/or credit card numbers.

Furthermore, and as is readily apparent to one of ordinary skill in the art, existing secure data communication protocols such as SSL and TLS do little to prevent the malicious and undesirable effects of spyware and scumware. This is so, because SSL and TLS ensure data content is unaltered as it is delivered from a WWW server to a WWW browser client, but SSL and TLS cannot detect dynamic alterations that are made to the data content when the WWW browser client renders the data content for presentation within the WWW browser client.

As is now apparent, there exists a need for improved techniques that securely present data content in an unaltered format within a client, irrespective of any communication protocol initially used to transfer the data content to client. Furthermore, there exists a need for techniques that detect spyware and scumware operating within a client, such that the effects of spyware and scumware applications can be communicated to a user within the client and in some cases undone, thereby providing data content in its unaltered and original format within the client.

### SUMMARY OF THE INVENTION

In various embodiments of the present invention, techniques for secure data content presentation are described. A client requests data content from a remote server. The client receives a key and the data content, and the client presents the data content if the received key is validated.

More specifically and in one embodiment of the present invention, a method for secure data content presentation is provided. A request for data content located on a remote server is received from a client. The data content is obtained from the remote server using the request, and a key is generated based on the data content. Next, the data content and the key are sent to the client

In another embodiment of the present invention, another method for secure data content presentation is presented. A request for data content that is accessible to a remote server is sent. The data content along with a key associated with the data content are received. The key is validated before presenting the data content, and if the key is valid, the data content is presented.

In still another embodiment of the present invention, a secure data content presentation system is described. The system includes a client, a proxy server, and a remote server. The client request data content from the remote server through the proxy server, and the proxy server acquires the data content from the remote server and generates a key based on the data content. Next, the proxy server transfers the data content and the key to the client, and the client validates the key before presenting the data content.

In yet another embodiment of the present invention, a data structure residing on a computer readable medium used for secure data content presentation is provided. The data structure includes data content and a key. The data content represents data requested from a remote server by a client. A proxy server generates the key, and the key uniquely identifies the data content and is operable to be validated by the client. Furthermore, the data content and the key are sent from the proxy server to the client, and the client validates the key before presenting the data content.

Still other aspects of the present invention will become apparent to those skilled in the art from the following description of various embodiments. As will be realized the invention is capable of other embodiments, all without departing from the present invention. Accordingly, the drawings and descriptions are illustrative in nature and not intended to be restrictive.

### BRIEF DESCRIPTION OF THE DRAWINGS

FIG. 1 is a flowchart representing a method for providing secure data content presentation, according to the teachings of the present invention;

FIG. 2 is a flowchart representing another method for providing secure data content presentation, according to the teachings of the present invention;

FIG. 3 is a flowchart representing a still another method for providing secure data content presentation, according to the teachings of the present invention;

FIG. 4 is a block diagram of a secure data content presentation system, according to the teachings of the present invention; and

FIG. 5 is a block diagram of a data structure, according to the teachings of the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

Software for the system is stored on one or more computer readable media. In one embodiment the software is stored on secondary storage, such as a disk drive, and loaded into main memory and cache of the computer as needed. The software is written in the form of executable instructions that generally provide a single function or subsets of related functions. However, in various embodiments, the software comprises a single module or many modules, and there is no requirement that functions be grouped together. Hardware and/or firmware are used to implement the invention in further embodiments. The software may implement the functions, or simply facilitate the performance of the function by a human by providing menu driven interfaces, or other means of providing information to the system for data storage.

As used herein a “client” refers to one or more software applications that are processing on a client-computing device. In one embodiment, a client is any commercially or publicly available WWW browser client, such as MICROSOFT'S INTERNET EXPLORER, NETSCAPE'S NAVIGATOR, an original WWW browser client (e.g., Mosaic), an online service provider's browser (e.g., American Online (AOL), Opera, and others. Of course any WWW browser client that uses HTTP, SSL, and/or TLS to request data content from a WWW server on behalf of the WWW browser client using an Internet network connection is intended to fall within the scope of the present disclosure.

Further, a “remote server” refers to one or more software applications that are processing on a remote-computing device (e.g., remote from the client-computing device). In one embodiment, the remote server is a WWW server hosting one or more web sites. The remote server is operable to receive and satisfy requests from a client for data content. The data content can be externally located from the remote server but is accessible and within the control of the remote server, such that the remote server can acquire the data content to satisfy a client's request. Similar to the client, the remote server uses HTTP, SSL, and/or TLS to receive client requests and deliver data content using an Internet network connection established with the client.

Moreover, a “proxy server” refers to one or more software applications that are processing on a computing device. The proxy server acts as an intermediary between a client and a remote server so that an enterprise can ensure security, administrative control, and provide a caching service to the client to improve the performance of interactions between the client and the remote server. A proxy server can be associated with an enterprise's gateway server that separates the enterprise's network from the external Internet and a firewall server that protects the enterprise's network from outside intrusion. A proxy server intercepts client requests for data content controlled by a remote server and searches cache for the data content to satisfy the requests. Moreover, the proxy server can filter the client requests to exclude undesirable requests. In most cases, the proxy server operates invisibly to the client within the enterprise.

Furthermore, in one embodiment, the present disclosure is implemented using a client, which is any commercially or publicly available WWW browser. The proxy server is an iChain product distributed by Novell, Inc. of Provo, Utah. And, the remote server is any available web site existing on the Internet and accessible via the WWW. Of course any client, proxy server, or remote server can be used without departing from the teachings of the present invention.

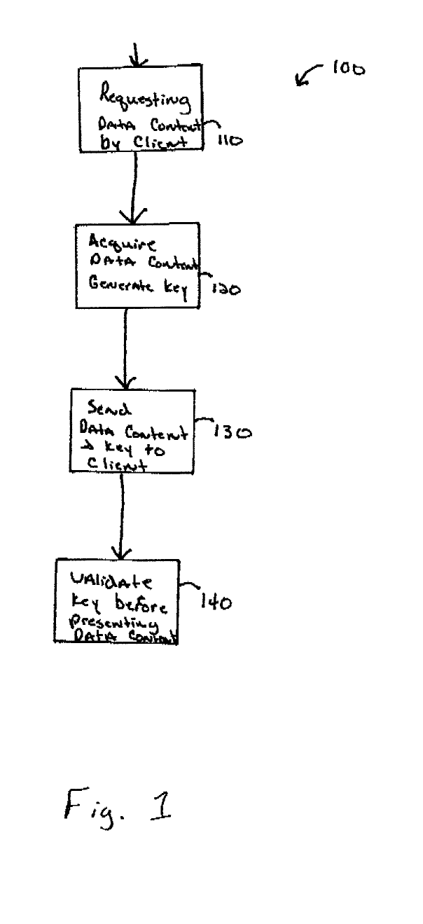

FIG. 1 illustrates a flowchart representing one method 100 for providing secure data content presentation, according to the teachings of the present invention. Initially in 110, a client, such as a WWW browser, activates a hypertext link associated with data content (e.g., a WWW page). The data content resides on or is otherwise accessible to a remote server (e.g., web site). When the client activates the hypertext link, a request for the hypertext link is first processed by a proxy server, which acts as an intermediary between the client and the remote server.

The proxy server then acquires the data content associated with the request (e.g., hypertext link) from the remote server. And in 120, the proxy server generates a unique key for the acquired data content. In some embodiments, the unique key is a digital signature generated against the acquired data content, such that if the data content is altered, then the signature of the altered data content will be different than the signature generated by the proxy server. In other embodiments, the key is a checksum value generated against the acquired data content using any convention or ad hoc checksum operation. In still other embodiments, the key is generated using a variety of custom developed metrics or heuristics that uniquely identify the acquired data content.

In 130, the acquired data content and the generated key are sent from the proxy server to the client. And, in 140 the client uses an algorithm that the proxy server used to generate the key to validate the data content before the data content is presented on the client. In order to ensure that no spyware or scumware is capable of altering the data content before it is presented in the client, the client executes the algorithm against the data content just prior to presenting the data content. In this way, any spyware or scumware secretly operating on the client is detectable when the algorithm, processing on the client, generates a second key that does not match the key sent from the proxy server.

If the client validates the key sent from the proxy server, then the data content is determined to be unaltered and is presented within the client. However, if the client does not validate the key sent from the proxy server, then the client, in some embodiments, is redirected to a notification page informing the client that the data content has been altered. In some embodiments, if the client does not validate the key sent from the proxy server, then the original data content is transparently reconstructed by the client back into the data content's original unaltered form. In these latter embodiments, the data content can be reconstructed using the original sent key and the client-generated key. For example, a Cyclical Redundancy Check (CRC) operation or multiple checksum operations can be performed against the altered data content to reconstruct the unaltered data content. In still more embodiments, the data content can be reconstructed to the unaltered format by transparently acquiring from the proxy server the data content and comparing it against the altered data content and precluding any changes that have occurred in the altered data content. Of course as one of ordinary skill in the art readily appreciates, a variety of techniques can be used to reconstruct the unaltered data content from the detected altered data content, all such techniques are intended to fall within the broad scope of the present invention.

As is now readily apparent to one of ordinary skill in the art, method 100 permits data content to be securely presented within a client. This allows for spyware and scumware to be detected within a client, and for the effects of the spyware and scumware to be reported to or undone by the client. Moreover, previous techniques ensure the secure delivery of data content to the client but have been unable to ensure the secure presentation of that data content within the client.

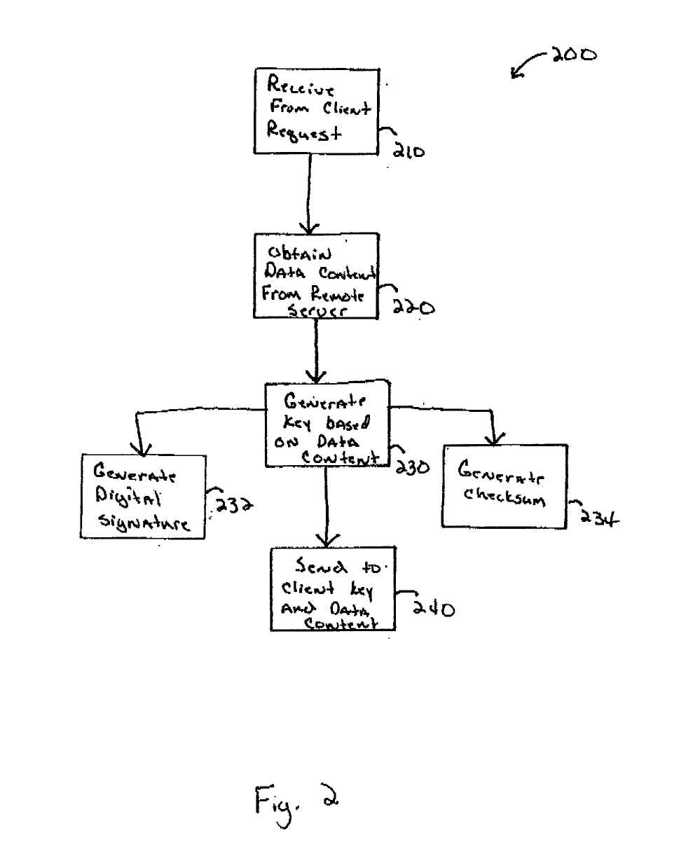

FIG. 2 illustrates a flowchart representing another method 200 that provides for secure data content presentation, according to the teachings of the present invention. In 210, a request is received from a client for data content. The data content is located on a remote server. In one embodiment, the client is a WWW browser and the remote server is a web site controlled by a WWW server. Furthermore, the request is a hypertext link represented as a Uniform Resource Locator (URL) address to the data content residing on the web site. Moreover, in one embodiment, the client and the remote server communicate using SSL or TLS communications over the Internet.

In 220, the request is used to acquire the data content from the remote server. Once the data content is acquired, in 230 a key is generated against the acquired data content. The key uniquely identifies the data content. In one embodiment, the key is generated as a digital signature in 232. In other embodiments, the key is a checksum value generated using a checksum operation in 234 against the acquired data content. In still other embodiments, the key is generated against the data content using any metrics or heuristics that uniquely identify the data content.

Once the key is generated, then the acquired data content and the generated key are sent to the client in 240. The client performs the same key generation algorithm against the received data content and compares the client-generated key against the received key to determine if the data content has been altered. The client performs the key generation and comparison operations just prior to or as the data content is presented within the client. In this way, if any spyware or scumware has altered the data content of added data content within the client, then the client detects the alterations and can take remedial actions, such as presenting a notification page or in some instances seamlessly reconstructing the original unaltered data content from the detected altered data content.

In one embodiment of method 200, the method 200 is implemented within a proxy server, such as an iChain product distributed by Novell, Inc. of Provo, Utah. The proxy server operates as an intermediary between the client and the remote server, providing additional security to the client within an enterprise.

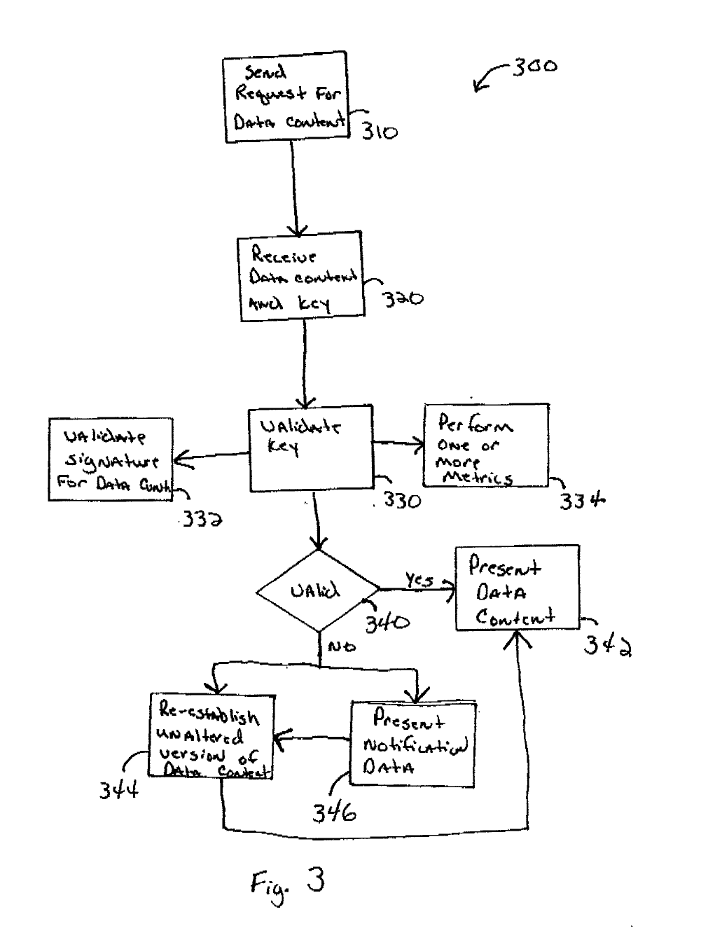

FIG. 3 illustrates a flowchart representing a still another method for providing secure data content presentation, according to the teachings of the present invention. In 310 a request is made for data content, where the data content is accessible to a remote server. In one embodiment, the remote server is a WWW server that controls or can otherwise access a web site that houses the data content represented by the request. Moreover, the request is an activated hypertext link represented as a URL address.

Next, in 320 the data content that satisfies the request is received along with a key that uniquely identifies the data content. In some embodiments, the data content and the key are received from a proxy server that acts as an intermediary between the processing of method 300 and the remote server, where the proxy server generates the key. Also, in one embodiment, the key is a digital signature. In other embodiments, the key is a checksum value generated against the data content. In still more embodiments, the key represents a value generated from the data content using one or more metrics or heuristics. In fact, any technique that uniquely identifies the data content or any portion of the data content can be used to generate the key.

In 330, the key is validated just prior to presenting the data content or as the data content is presented. If the key is a digital signature, then in 332 a second digital signature is generated against the data content and the second digital signature is compared against the received digital signature in order to validate the key. If the key is a value generated from performing one or more metrics or heuristics, then in 334 the one or more metrics are performed against the data content to generate a second value in order to validate the key. Moreover, in one embodiment, method 300 is implemented within a WWW browser, such that the key is validated within the WWW browser by processing a validation set of executable instructions before attempting to present the data content within the WWW browser.

In 340, a check is made to determine if the key is validated, and if so, the data content is presented in 342. Otherwise, the data content has been altered, which in some instances indicates that spyware or scumware has been detected or is otherwise operational. If the data content has been altered, then, in one embodiment, the original unaltered version of the data content is re-established in 344, and the unaltered version of the data content is presented in 342.

The unaltered version of the data content can be re-established using a variety of techniques, such as comparing the altered data content against the unaltered version of the data content and precluding any changes detected in the unaltered version of the data content, or the data content can be re-established by using CRC operations against the originally received key, the generated key for validation purposes, and the altered version of the data content. Moreover, in other embodiments, if the data content has been altered, then in 346 a notification can be optionally presented indicated that the data content has been altered. Furthermore, in some embodiments, the detected altered data content can be re-established to the data content's unaltered version and presented along with a notification indicating that the unaltered version of the data content had to be re-established.

One of ordinary skill in the art now understands by reading the above provided description, how data content can be securely presented in an unaltered format with the teachings of the present disclosure. This description can be used to compliment existing techniques that securely transmit data content but are unable to ensure that the data content is ultimately securely presented.

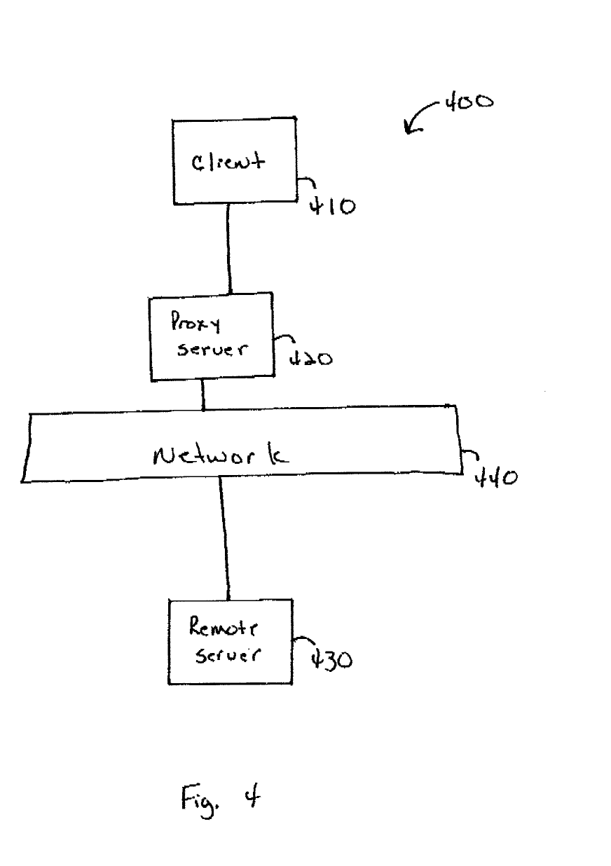

FIG. 4 illustrates a block diagram for one secure data content presentation system 400, according to the teachings of the present invention. The system includes a client 410, a proxy server 420, and a remote server 430. The client 410 and the proxy server 420 can be interfaced over the WWW with the remote server 430 through a network 440, such as the Internet. Moreover, in some embodiments, the client 410 is a WWW browser and the remote server 430 is a WWW server. Further, in one embodiment, the proxy server 420 is an iChain product distributed by Novell, Inc. of Provo, Utah.

The client 410 requests data content from the remote server 430 via the proxy server 420 that acts as an intermediary between the client 410 and the remote server 430. The proxy server 420 acquires the data content from the remote server 430 on behalf of the client 410. Next, the proxy server 420 generates a key that uniquely identifies the acquired data content. In one embodiment, the key is a digital signature for the data content. In other embodiments, the key is a checksum value or a value representing one or more metric or heuristic operations performed against the data content by the proxy server 420.

The proxy server 420 transfers the data content and the proxy server 420 generated key to the client 410. Next, the client 410 performs its own key generation operation against the data content received from the proxy server 420, just prior to any attempt by the client 410 to present the data content within the client. The client 410 uses the same key generation operation as what is used by the proxy server 420. Further, the client 410 compares the client 410 generated key against the proxy server 420 generated key in order to validate that the data content has not been altered.

In some embodiments, if the client 410 generated key does not match the proxy server 420 generated key for the data content, then the client 410 prevents the altered data content from being presented within the client 410. Moreover, the client 410 can present a notification within the client 410 indicating that the data content has been altered and could therefore be associated with a rogue spyware or scumware application processing within the client 410. Additionally, the client 410 can reconstruct the original and unaltered data content and present the unaltered data content within the client 410. Comparing the altered data content against the received data content from the proxy server 420, and precluding any changes detected in the altered data content from being presented within the client 410 can achieve reconstruction of the unaltered data content. Moreover, reconstruction of the unaltered data content can be achieved by performing multiple checksum operations or CRC operations against the altered data content when compared to the proxy server 420 generated key and the client 410 generated key.

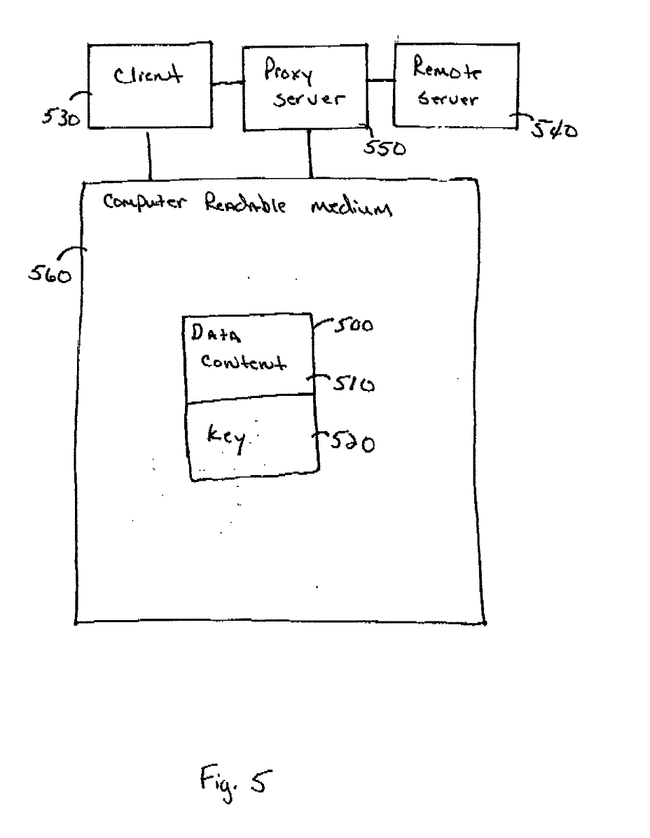

FIG. 5 illustrates a block diagram for one data structure 500, according to the teachings of the present invention. The data structure 500 includes data content 510 and a key 520. The data content 510 represents data requested by a client 530, where the data content 510 originally was acquired from a remote server 540. A proxy server 550 acts as an intermediary between the client 530 and the remote server 540 to acquire the data content 510 from the remote server 540 on behalf of the client 530.

Moreover, the proxy server 550 generates the key 520, such that the key 520 uniquely identifies the data content 510 and is operable to be recreated by the client 530. The proxy server 550 sends data structure 500 to the client 530, where the client 530 generates a second key and compares the second key against the key 520 to determine if the data content 510 has been altered. The client 530 performs the key comparison just before attempting to display the data content 510 within the client 510.

The data structure 500 resides or is otherwise accessible from one or more computer readable media 560. The computer readable media 560 can be volatile or non-volatile storage or memory. Moreover, as one of ordinary skill in the art readily appreciates, the data structure 500 need not be physically and contiguously stored within the computer readable media 560, since the data content 510 can be logically associated with the key 520.

Furthermore, in some embodiments, the remote server 540 is a WWW server controlling one or more websites, and the client 530 is a WWW browser. Additionally, the key 520 can be a digital signature, a checksum value, or a value obtained by performing one or more metrics or heuristics against the data content 510. Also, in one embodiment, the data content 510 is a WWW page originally requested by the client 530, when the client 530 activates a hypertext link embodied as a URL address.

If the client 530 does not validate the key 520 associated with the data content 510, then the client 530 can present a notification within the client 530 that indicates the data content 510 has been altered when the client 530 attempted to present the data content 510 within the client 530. In some embodiments, the client 530 reconstructs the data content 510, if the client 530 detects that the data content 510 has been altered when the key 520 is not successfully validated. The client 530 can reconstruct the data content 510 by precluding changes detected in an altered form of the data content 510 when compared to the originally received data content 510 from the proxy server 550. Moreover, the client 530 can use any technique to reconstruct the original unaltered data content 510, by using multiple checksum operations or CRC operations against the altered data content 510, the key 520, and a client 520 generated key used for validated the key 520.

One of ordinary skill in the art now appreciates that data content can be securely presented within a client using the teachings of the present invention. The secure data content can be presented even when rogue spyware and scumware applications are processing undetected on the client. This compliments existing techniques that ensure that data content is securely delivered to the client, when such techniques are unable to also guarantee that the securely delivered data content is not subsequently altered within the client before being presented within the client. The teachings of the present invention are particular well suited in a WWW environment utilizing a WWW browser client and a proxy server that acts as an intermediary between the WWW browser client and a WWW server.

The foregoing description of various embodiments of the invention has been presented for purposes of illustration and description. It is not intended to be exhaustive nor to limit the invention to the precise form disclosed. Many alternatives, modifications, and variations will be apparent to those skilled in the art in light of the above teaching. For example, although various embodiments of the invention have been described as a series of sequential steps, the invention is not limited to performing any particular steps in any particular order. Accordingly, this invention is intended to embrace all alternatives, modifications, equivalents, and variations that fall within the spirit and broad scope of the attached claims.

What is claimed is:

1. A method for secure data content presentation, comprising:
receiving from a client a request for data content located on a remote server;
obtaining the data content from the remote server using the request;
generating a key based on the data content; and
sending to the client the data content and the key.

2. The method of claim 1, wherein in receiving the request, the request is a Uniform Resource Locator (URL) address.

3. The method of claim 1, wherein in obtaining the data content, the remote server is a World Wide Web (WWW) server.

4. The method of claim 1, wherein in generating the key, the key is a digital signature.

5. The method of claim 1, wherein in generating the key, the key is generated using a checksum operation performed against the content data.

6. The method of claim 1, wherein in receiving the request, the client is a WWW browser.

7. The method of claim 1 wherein in sending the data content, the data content is sent using a Secure Sockets Layer (SSL) data communication protocol over the Internet.

8. A method for secure data content presentation, comprising:
sending a request for data content, wherein the data content is accessible to a remote server;
receiving the data content along with a key for the data content; and
validating the key before presenting the data content, and if the key is valid presenting the data content.

9. The method of claim 7, wherein in receiving the data content, the data content and the key are sent by a proxy server.

10. The method of claim 7, wherein in validating the key, the key is validated within a World Wide Web (WWW) browser by processing a validation set of executable instructions before attempting to present the data content within the WWW browser.

11. The method of claim 7, wherein in validating the key, the key is validated by performing one or more metrics against the data content to produce a value, and wherein the key is validated if the value equals the key.

12. The method of claim 7, wherein in receiving the data content, the key is a signature for the data content.

13. The method of claim 7, further comprising re-establishing an unaltered version of the data content if the key is not validated and then displaying the unaltered version of the content data.

14. The method of claim 8, wherein in re-establishing the unaltered version of the data content, the unaltered version of the data content is reconstructed using a Cyclical Redundancy Check (CRC) operation.

15. The method of claim 7, further comprising presenting notification data indicating that the data content has been altered if the key is not validated.

16. A secure data content presentation system, comprising:
a client;
a proxy server;
a remote server; and
wherein the client requests data content from the remote server through the proxy server, and the proxy server acquires the data content from the remote server and generates a key based on the data content, the proxy server transfers the data content and the key to the client, and the client validates the key before presenting the data content.

17. The system of claim 15, wherein the client, the proxy server, and the remote server are interfaced over the World Wide Web (WWW) using an Internet connection.

18. The system of claim 16, wherein the client is a WWW browser, and the remote server is a WWW server.

19. The system of claim 15, wherein the client uses the key to detect modifications in the data content when the key is not validated, and prevents the changes from being presented on the client.

20. The system of claim 15, wherein the client presents a notification of any detected modifications in the data content when the key is not validated.

21. The system of claim 15, wherein the key is at least one of a signature for the data content and a checksum value for the data content.

22. A data structure residing on a computer readable medium used for secure data content presentation, comprising:
data content representing data requested from a remote server by a client;
a key generated by a proxy server, wherein the key uniquely identifies the data content and is operable to be validated by the client; and
wherein the data content and the key are sent from the proxy server to the client, and the client validates the key before presenting the data content.

23. The data structure of claim 20, wherein the remote server is a World Wide Web (WWW) server, the client is a WWW browser, and the key is a signature for the data content.

24. The data structure of claim 20, wherein the client presents a notification if the key is not validated.

25. The data structure of claim 20, wherein the data content is a WWW page.

26. The data structure of claim 20, wherein the client validates the key immediately prior to attempting to present the data content.

27. The data structure of claim 20, wherein the client presents an unaltered version of the data content if the key is not validated.
